(19) United States
(12) Patent Application Publication
(10) Pub. No.: US 2021/0287246 A1
(43) Pub. Date: Sep. 16, 2021

(54) VISUALIZATION OF DYNAMIC EVENTS AND ANOMALY DETECTION

(71) Applicant: salesforce.com, inc., San Francisco, CA (US)

(72) Inventors: Yuxi Zhang, San Francisco, CA (US); Kexin Xie, San Mateo, CA (US)

(21) Appl. No.: 16/818,016

(22) Filed: Mar. 13, 2020

(51) Int. Cl. G06Q 30/02

(52) U.S. Cl. CPC G06Q 30/0242

(57) ABSTRACT

Systems, device and techniques are disclosed for asynchronous remote call with undo data structures. A selection of a data point of a time series may be received. The data point may represent a measurement of an overall target metric for events at a point in time. A graph for the data point may be displayed on a display device. The display of the graph for the data point may include nodes for the events displayed with sizes based on an influence scores for the events, and an edge between each of the nodes and a hidden node, with a width that may represent an adjusted change in a measurement of a target metric for the event corresponding to the node, and a color of the edge may represent whether the adjusted change in the measurement of the target metric for the event is positive or negative.

### BACKGROUND

Marketing campaigns may include events that may be related in various ways. The marketing campaign may be dynamic, with events lasting for different amounts of time, and events being added and removed over the course of the marketing campaign. Events may influence other events to which they are directly connected, but may also influence non-directly connected events. It may be difficult to analyze metrics measured for the events of a marketing campaign to determine how different events affect the overall marketing campaign, and to detect anomalies in the performance of events based on the measured metrics.

### BRIEF DESCRIPTION OF THE DRAWINGS

The accompanying drawings, which are included to provide a further understanding of the disclosed subject matter, are incorporated in and constitute a part of this specification. The drawings also illustrate implementations of the disclosed subject matter and together with the detailed description serve to explain the principles of implementations of the disclosed subject matter. No attempt is made to show structural details in more detail than may be necessary for a fundamental understanding of the disclosed subject matter and various ways in which it may be practiced.

FIG. 1 shows an example system for visualization of dynamic events and anomaly detection according to an implementation of the disclosed subject matter.

FIG. 2 shows an example arrangement for visualization of dynamic events and anomaly detection according to an implementation of the disclosed subject matter.

FIG. 3 shows an example arrangement for visualization of dynamic events and anomaly detection according to an implementation of the disclosed subject matter.

FIG. 4 shows an example arrangement for visualization of dynamic events and anomaly detection according to an implementation of the disclosed subject matter.

FIG. 5 shows an example visualization for visualization of dynamic events and anomaly detection according to an implementation of the disclosed subject matter.

FIG. 6 shows an example arrangement for visualization of dynamic events and anomaly detection according to an implementation of the disclosed subject matter.

FIG. 7 shows an example visualization for visualization of dynamic events and anomaly detection according to an implementation of the disclosed subject matter.

FIG. 8 shows an example visualization for visualization of dynamic events and anomaly detection according to an implementation of the disclosed subject matter.

FIG. 9 shows an example visualization suitable for visualization of dynamic events and anomaly detection according to an implementation of the disclosed subject matter.

FIG. 10 shows an example procedure suitable for visualization of dynamic events and anomaly detection according to an implementation of the disclosed subject matter.

FIG. 11 shows an example procedure suitable for visualization of dynamic events and anomaly detection according to an implementation of the disclosed subject matter.

FIG. 12 shows an example procedure suitable for visualization of dynamic events and anomaly detection according to an implementation of the disclosed subject matter.

FIG. 13 shows a computer according to an implementation of the disclosed subject matter.

FIG. 14 shows a network configuration according to an implementation of the disclosed subject matter.

### DETAILED DESCRIPTION

Techniques disclosed herein enable visualization of dynamic events and anomaly detection, which may allow for a graph representing a data point from a time series and including nodes representing events from that data point to be displayed. Events may be monitored, with metrics for the events being measured. At a point in time, a data point may be generated using the metrics for the events measured from the last point in time at which a data point was generated to the current point in time. The measurements for the metrics for the events may be used to determine an influence score and changes in measurements of target metrics for each event. The changes in measurements for target metrics may be adjusted using the influence scores. The influence scores and measurements of the target metrics may be used to determine a measurement of an overall target metric for the data point. The data point may be added to a time series. Anomaly detection may be applied to the data points of the time series. The time series may be visually displayed to a user. The user may select a data point from the time series which may cause a graph for the data point to be visually displayed to the user. The graph may include nodes representing the events from the data point and a hidden node. Edges may connect the nodes to the hidden node. The influence score of an event may be represented by the size of the node displayed for the event. The magnitude of an adjusted change in the measurement of the target metric for the event relative to a previous data point may be represented by the width of an edge displayed between the node for the event and the hidden node. Whether the adjusted change in the measurement of the target metric for the event is positive or negative may be represented by the color of the edge between the node for the event and the hidden node.

Events may be monitored, with metrics for the events being measured. The events may be associated with a campaign, such as, for example, a marketing campaign. The events may be, for example, electronic communications associated with a campaign. For example, an event may be the sending of emails, the sending of push notifications, the serving of webpages for a product, or the serving of webpages for checking out of an online store. Different types of emails or push notifications that are part of the same marketing campaign may be considered to be separate events. For example, the sending of promotional emails for the campaign may be an event, and the sending of welcome emails to users who have signed up to receive a newsletter may be a separate event from the sending of the promotional emails. Any suitable metrics for the monitored events may be measured. For example, the metrics measured for the events may include a traffic volume metric and a target metric. The traffic volume metric may be measured according to the event type, and the measurement of the traffic volume metric may be a measurement of volume for that event type. For example, a measurement of a traffic volume metric for the sending of emails may be a measurement of the number of emails sent, or the number of emails that are successfully delivered. A measurement of a traffic volume metric for the serving of a webpage, such as a webpage for a product, may be a measurement of the number of times the webpage is served, either in total, or to unique users. The target metric may be measured according to the event type and may be, for example, a measurement of engagement, which may be the number of times a user interacts with an event. For example, the measurement of a target metric for the sending of emails may be a measurement of the number of users that open the emails, or the number of users that visit a webpage by using a hyperlink in the emails. A measurement of a target metric for the serving of a webpage for a product may be a measurement of the number of times users add the product to an online shopping cart using the webpage. A measurement of a target metric for the serving of a webpage for checking out of an online store may be a measurement of the number of users who complete the checkout process to place an order through the online store.

Events may be monitored, and metrics may be measured, in any suitable manner. For example, computing devices or systems responsible for generating the events, such as server systems used for emailing or webservers that serve webpages for products and for checking out of an online store, may monitor the events that they generate themselves and measure the metrics for the events, or a separate computing device or system may monitor the events and measure the metrics for the events. Metrics measured by different computing devices or systems for events that are part of the same campaign may be sent to a single computing device or system that may perform analytics with the metric measurements.

At a point in time, a data point may be generated using the metrics for the events measured from the time period between the last point in time at which a data point was generated and the current point in time. A data point may be generated at any suitable time, and data points may be generated at any suitable intervals. The intervals at which data points for a campaign are generated may be regular, or may vary over the life of the campaign. For example, a data point for a campaign may be generated at a regular interval of once every 24 hours over the life of the campaign, with each data point including metrics measured for the events of the campaign over the preceding 24 hours. A data point for a campaign may be generated at irregular intervals, for example, based on the occurrence of certain events, such as the introduction of events to or removal of events from the campaign.

The measurements for the metrics for the events may be used to determine an influence score for each event. At the time a data point is generated for a campaign, the measurements for traffic volume metrics for the events of the campaign may be used to determine influence scores for each of the events of the campaign. All of the measurements for traffic volume metrics may be summed to a total traffic volume measurement for the data point. The influence score for each event may be the ratio of the measurement of the traffic volume metric for that event to the total traffic volume measurement for the data point. The influence score may indicate the percentage of the total traffic volume of the campaign that the event is responsible for at the data point being generated. For example, a data point being generated may include four events, such as the sending of emails, the sending of push notifications, the serving of a webpage for a product, and the serving of a webpage for checking out from an online store. The total traffic volume measurement for all four events may be 200,000. The influence score for an event, for example, the sending out of push notifications, whose traffic volume metric was measured at a 50,000 over the time period between the generation of the data point and the immediately prior data point may be 50,000/200,000=0.25. The influence score may be expressed in any suitable manner, including as a fraction or a percentage. The influence scores for any data point may add up to the 1, or 100%, so that influence scores may be normalized across all data points for a campaign.

Changes in the influence score may be determined for each event. For each event that is common to a data point being generated and the immediately prior data point, the influence score determined for the event during the generation of the data point may have the influence score for the event from the immediately prior data subtracted from it to determine the change in influence score for the event. For example, an event may have an influence score of 0.25 for a data point that is being generated, and an influence score of 0.2 for the immediately prior data point. The change in influence score for the event may be 0.25-0.2=0.05. A change in influence score for an event may be positive or negative.

Changes in measurements of target metrics may be determined for each event. At the time a data point is generated, the measurement of the target metric for an event from an immediately prior data point may be subtracted from the measurement of the target metric for the event from the data point being generated for each event that is common to the data point being generated and the immediately prior data point. The results may be the changes in measurements of the target metrics for the events from the data point being generated. For example, the event may be the serving of a webpage for a product, and the target metric may be measured based on the number of times the product on the webpage was added to an online shopping cart. Data points may be generated every 24 hours, the event of serving the webpage for the product may have a measurement of a target metric of 5000, and the measurement of the target metric for the same event, the serving of the webpage for the product, from the data point generated 24 hours prior may be 3000, resulting in a change in measurement of the target metric for the event of 5000-3000=2000 for the data point being generated.

The change in measurement of the target metric for an event may be positive or negative. For example, if the measurement of the target metric for the same event from the data point generated 24 hours prior was 6000, the change in measurement of the target metric for the event at the data point being generated may be 5000-6000=−1000. If an event from the data point being generated is new, so that there is no measurement of the target metric for the event in the immediately prior data point, the change in measurement of the target metric for the event may be set to the measurement of the target metric for the event. For example, an event from the data point being generated may have a measurement of a target metric of 4000, and the event may not appear in the immediately prior data point, resulting in a change in measurement of the target metric of 4000 for the event from the data point being crated.

The changes in measurements for target metrics may be adjusted using changes in influence scores. An event may have its change in measurement of the target metric adjusted by its change in influence score. An event with a positive change in influence score may have its change in measurement of a target metric increased in magnitude, while an event with a negative change in influence score may have its change in measurement of a target metric reduced. The increases and reductions may be of any suitable magnitude and may be, for example, based on the magnitude of the change in influence score for an event. The change in measurement of a target metric for an event may be adjusted using the change in influence score by, for example, multiplying the change in measurement of a target metric by one plus the change in influence score. This may generate an adjusted change in measurement of the target metric for the event. For example, an event for a data point being generated may have a change in measurement of a target metric of 2000, and may have a change in influence score change of 0.05. The adjusted change in measurement of the target metric for the event may be 2000*1.05=2100. Adjusted changes in measurements of target metrics may be generated for all of the events from the data point being generated.

The adjusted changes in measurements of target metrics may be further adjusted using the influence scores of the events from the data point being generated. The influence scores may be used to generate an estimated order for the events. For example, the events may be ordered in descending order of influence score, with the event with the highest influence score first in the estimated order, and the event with the lowest influence score last in the estimated order. The ordering of events according to influence score may be an estimate of a connectivity structure for the events. For example, a data point may include four events, the sending of emails, with an influence score of 0.6, the sending of push notifications, with an influence score of 0.25, the serving of webpages for a product, with an influence score of 0.1, and the serving of webpages for checking out of an online store, with an influence score of 0.05. Ordering the events according to their influence scores may be an estimate of the order in which users experience the events of the campaign. For example, a user may first receive an email, which may be followed by receiving a push notification, visiting a webpage for a product, and then visiting the checkout webpage for an online store.

The adjusted changes in measurements of target metrics for events from the data point being generated may be further adjusted based on the position in which the events appear in the estimated order of events by influence score. Events that appear closer to the beginning of the estimated order, for example, events with higher influence scores, may have their adjusted changes in measurements of the target metrics reduced, or down weighted. Events that appear closer to the end of the estimated order, for example, events with lower influence scores, may have their adjusted changes in measurements of the target metrics increased, or up weighted. The down weighting and up weighting may be performed by applying an exponential decay effect to the events and their adjusted changes in measurements of the target metrics based on their positions in the estimated order of events.

The influence scores and measurements of target metrics may be used to determine a measurement of an overall target metric for the data point. The influence scores and measurements of target metrics of the target metrics for all of the events from a data point being generated may be blended in any suitable manner into a measurement of an overall target metric for the data point being generated in any suitable manner. For example, the influence score for each event may be multiplied by the measurement of the target metric for the event, and the results may be summed across all events from the data point being generated to generate the overall target metric measurement for the data point being generated.

The data point may be added to a time series. The time series may include data points generated for the same campaign at various points in time in chronological order. Each data point may include a timestamp that may indicate when the data point was created, or the time period of the campaign that the data point represents. The time series may be one-dimensional, and data points may be represented in the time series by their overall target metric measurements.

Anomaly detection may be applied to the data points of the time series. Any suitable anomaly detection for one-dimensional series may be applied to the data points of the time series. For example, the data points in a time series may be analyzed using a short look back window, and upper and lower confidence bounds may be derived with a 95% confidence interval. Any data points that are outside of the upper and lower bounds based on their overall target metric measurements may be flagged as being anomalous. For example, a marketing campaign may run for 30 weeks. A new data point for the marketing campaign may be generated every 24 hours, resulting in 210 data points in a time series for the marketing campaign. Anomaly detection may be applied to the time series for the marking campaign each time one of the 210 data points is generated and added to the time series, and may result in some number of the 210 data points being flagged as anomalous at various points in time during the marketing campaign. The flagged data points may have overall target metric measurements that are much higher or much lower than other data points that are analyzed within the same look back window.

The time series may be visually displayed to a user. The time series may be displayed to a user of a computing device on a display device of the computing device. The time series may be displayed, for example, as a two-dimensional graph, with the x-axis representing time and the y-axis representing the overall target metric. A visual representation of each data point in the time series may be positioned on the two-dimensional graph based on the timestamp for the data point, for example, the time at which the data point was generated, and the overall target metric measurement for the data point. Data points that have been flagged during anomaly detection may be visually distinguished from other data points, for example, through color, shape, or in any other suitable manner.

A graph for a data point from the time series may be visually displayed to the user. For example, a user may use a user interface of the computing device to select one of the data points from the two-dimensional graph of the time series. The user may, for example, select a data point that has been flagged as anomalous. A graph for the selected data point may be visually displayed to the user on the display device of the computing device.

The graph displayed for a selected data point may include nodes representing the events from the data point and a hidden node. For example, if the data point included five events, the graph displayed for the data point may include five nodes and a single hidden node. The size of a node may represent the influence score determined for the event represented by the node. For example, a node representing an event with an influence score of 0.6 may be displayed as being twice as large as a node representing an event with an influence score 0.3. This may allow a user to visually assess the relative influence scores of the events represented by the nodes in the graph for the data point, and determine which events had the most and least influence on the overall target metric for the data point.

Edges may connect the nodes to the hidden node. The graph displayed for a selected data point may include an edge between each displayed node and the hidden node. The width of an edge between a node and the hidden node may represent the magnitude of an adjusted change in the measurement of a target metric for the event represented by the node. For example, a node representing an event with an adjusted change in the measurement of the target metric of 2000 may be connected to the hidden node by an edge that is twice as wide as the edge between the hidden node and a node representing an event with an adjusted change in the measurement of the target metric of 1000. An edge between a node and hidden node may also visually display whether the adjusted change in the measurement of the target metric for the event represented by the node is positive or negative. For example, the edge may be colored, with one color, for example, green or white, representing a positive change in the measurement of the target metric, and a second color, for example, red or black, representing a negative change in the measurement of the target metric. This may allow a user to visually assess both how much a measurement of a target metric for an event has changed since the immediately previous data point in the time series, and whether the change was an increase or decrease in the measurement. A user may thus be able to examine a graph for a data point that has been flagged as anomalous in a time series and visually identify which events may have been responsible for the anomaly. For example, the graph for a data point that has been flagged as anomalous may have its largest node connected to the hidden node by an edge that is both wider than all of the other edges of the graph and colored red, indicating a large negative change in the measurement of the target metric from the immediately prior data point for the event represented by that node. The user may determine that the event that the node represents, for example, the sending of emails, experienced a large decrease in its target metric, for example, recipients of the emails opening the email, over the time period since the prior data point was generated, and this may have resulted in a large decrease in the overall target metric measurement for the anomalous data point.

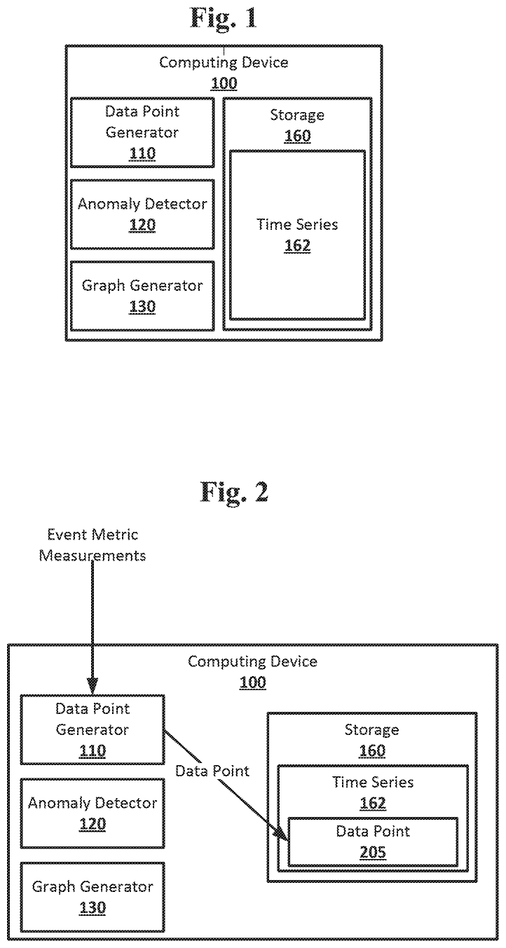

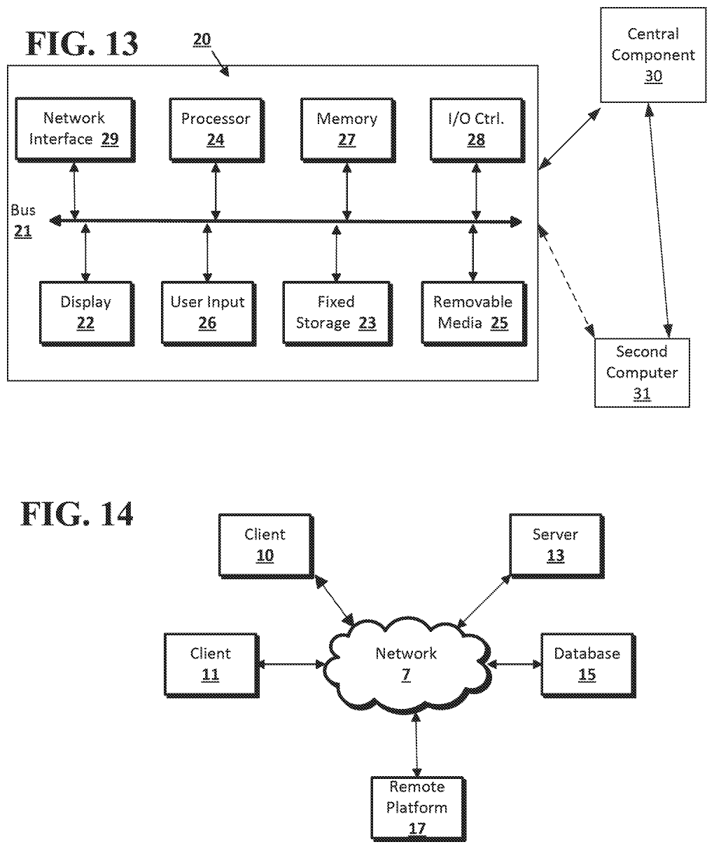

FIG. 1 shows an example system for visualization of dynamic events and anomaly detection according to an implementation of the disclosed subject matter. A computing device 100 may be any suitable computing device, such as, for example, a computer 20 as described in FIG. 13, or component thereof. The computing device 100 may include a data point generator 110, anomaly detector 120, graph generator 130, and a storage 160. The computing device 100 may be a single computing device, or may include multiple connected computing devices, and may be, for example, a laptop, a desktop, an individual server, a server cluster, a server farm, or a distributed server system, or may be a virtual computing device or system, or any suitable combination of physical and virtual systems. The computing device 100 may be part of a computing system and network infrastructure, or may be otherwise connected to the computing system and network infrastructure, including a larger server network which may include other server systems similar to the computing device 100. The computing device 100 may include any suitable combination of central processing units (CPUs), graphical processing units (GPUs), and tensor processing units (TPUs). The computing device 100 may, for example, be part of a server system that analyzes and generates visualizations from measurements of event metrics.

The data point generator 110 may be any suitable combination of hardware and software on the computing device 100 for generating a data point from measurements of event metrics. The data point generator 110 may, for example, use traffic volume metrics and target metrics measured for events over a period of time to generate a data point for those events over that period of time. A data point generated by the data point generator 110 may include data such as, for example, a timestamp, a measurement for an overall target metric, measurements of traffic volume metrics and target metrics for each event, influence scores for each of the events, changes in influence score for each of the events, and adjusted changes in the measurements of target metrics for each event.

The anomaly detector 120 may be any suitable combination of hardware and software on the computing device 100 for detecting anomalies in a time series. The anomaly detector 120 may apply any suitable one-dimensional anomaly detection to the data points of a time series, such as the time series 162, and may flag any anomalous data points. The anomaly detector 120 may be applied to a time series at any suitable time. For example, the anomaly detector 120 may be applied to a time series every time the data point generator 110 adds a new data point to the time series.

The graph generator 130 may be any suitable combination of hardware and software on the computing device 100 for generating visualizations of time series and data points. The graph generator 130 may, for example, generate a two-dimensional graph of a time series using the data points from the time series, which may be a one-dimensional series of data points. Data points in a time series flagged as anomalous by the anomaly detector 120 may be visually marked, for example, through coloration, on the graph of the time series. The graph generator 130 may generate a visualization of a data point of the time series 162 using data from the data point. The visualization of the data point may be, for example, a graph that includes various nodes representing events in the data point connected by edges to a hidden node. The graph generator 130 may represent data from the data point in the graph that visualizes the data point. For example, the size of nodes in the graph may represent the influence scores of the events represented by the nodes. The widths of edges between the nodes and the hidden node in the graph may represent the magnitude of the adjusted changes in the measurements of target metrics for the events represented by the nodes. The edges between the nodes and hidden node may also visually display whether the adjusted changes in the measurements of the target metrics for the events represented by the nodes are positive or negative, for example, using different colorings of the edges.

The storage 160 may be any suitable combination of hardware and software for storing data. The storage 160 may include any suitable combination of volatile and non-volatile storage hardware, and may include components of the computing device 100 and hardware accessible to the computing device 100, for example, through wired and wireless direct or network connections. The storage 160 may time series, such as the time series 162. The time series 162 may be a one-dimensional time series including data points generated by the data point generator 110. All of the data points in the time series 162 may be for events that are part of the same campaign, such as, for example, a marketing campaign. The data points may be generated at various points over the life of the campaign and added to the time series 162.

FIG. 2 shows an example arrangement for visualization of dynamic events and anomaly detection according to an implementation of the disclosed subject matter. The data point generator 110 may receive event metric measurements. The event metric measurements may be measurements of metrics taken for monitored events in any suitable manner. The event metric measurements may, for example, be taken by computing devices or systems separate from the computing device 100, such as, for example, an email server system or webpage server system, or may be taken by the computing device 100. The event metric measurements may include metrics for any suitable events. For example, the events may be part of a campaign, such as a marketing campaign, and may include, for example, the sending of emails, sending of push notifications, serving of a webpage for a product, serving of a webpage for checking out of an online store, or any other suitable form of electronic communication that may be part of such a marketing campaign. The data point generator 110 may receive event metric measurements continuously, for example, as they are measured, or may receive event metric measurements and any suitable intervals.

The data point generator 110 may use the event metric measurements to generate a data point. The data point generator 110 may use event metric measurements taken over a specified time period, such as, for example, from between the time an immediately prior data point was generated and the time the current data point is being generated. The data point generator 110 may generate the data for a data point 205, including, for example, influence scores, changes in influence scores, changes in measurements of overall target metrics for events for which event metric measurements were received, and a measurement of an overall target metric for the data point 205. The influence scores may be based on, for example, measurements of traffic volumes for the events. The changes in influence scores may be based on, for example, the influence scores for the events from the data point being generated and influence scores for the events from an immediately prior data point. The changes in measurements of target metrics may be based on, for example, the measurements of target metrics for the events from the data point being generated and the measurements of target metrics for the events from an immediately prior data point. The data generator 110 may use the changes in measurements of target metrics, influence scores, and changes in influence scores, to generate adjusted changes in measurements of the target metrics for the events from the data point being created. For example, the data point generator 110 may adjust changes in measurements of target metrics for events based on the positions of events in an estimated ordering of the events by influence score and based on the changes in influence scores for the events.

The data point 205 may be stored in the storage 160 as part of the time series 162. The time series 162 may include any number of data points generated by the data point generator 110 based on events from the same campaign. The data points in the time series 162, such as the data point 205, may include timestamp data that may indicate the time each data point was generated by the datapoint generator 110, or the time of the latest event metric measurement used to generate the data point. Events in the data points may vary across different data points in the time series 162, as events may be added to or removed from a campaign at various times. For example, the data point 205 may include an event that was not included in the immediately prior data point in the time series, and may not include an event that was included in the immediately prior data point in the time series.

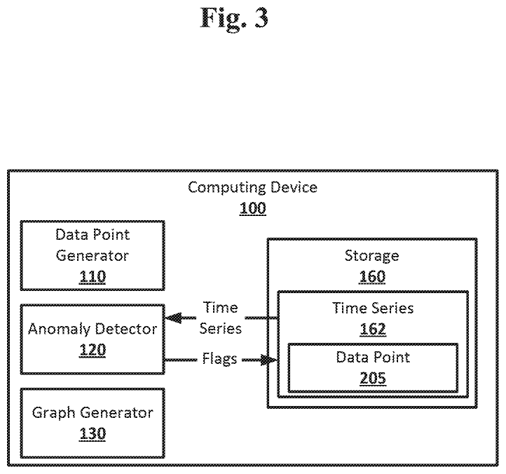

FIG. 3 shows an example arrangement for visualization of dynamic events and anomaly detection according to an implementation of the disclosed subject matter. The anomaly detector 120 may apply any suitable one-dimensional anomaly detection to the data points of the time series 162, including the data point 205 which may have just been added to the time series 162 by the data point generator 110. The anomaly detector 120 may flag any anomalous data points. The flags may be stored with the time series 162, for example, as a property of a flagged data point or separate data, for example, a list of flagged data points stored as metadata for the time series 162.

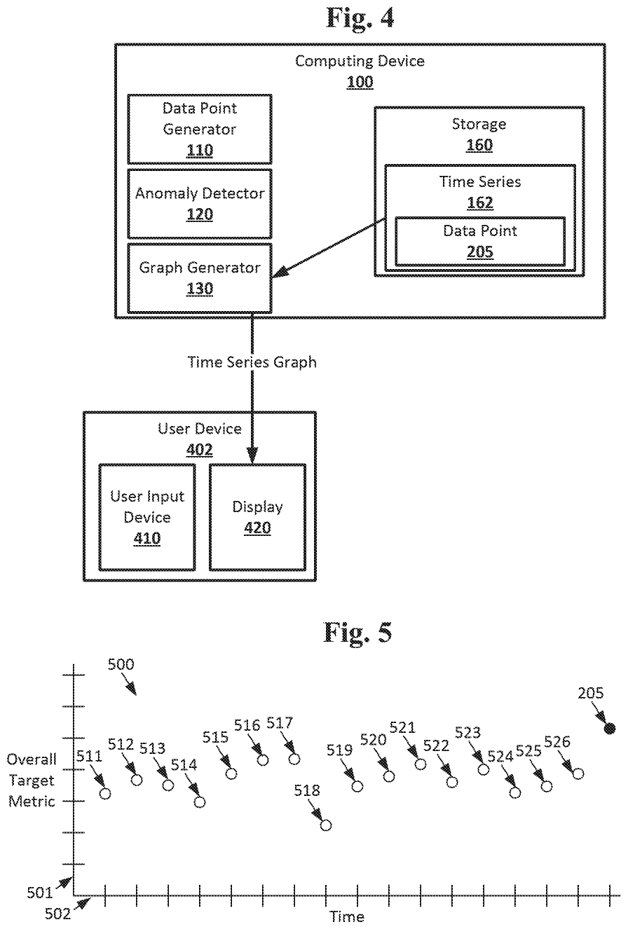

FIG. 4 shows an example arrangement for visualization of dynamic events and anomaly detection according to an implementation of the disclosed subject matter. The graph generator 130 may generate a time series graph for the time series 162. The time series graph may be sent to a user device 402 to be displayed on a display 420.

The user device 402 may be any suitable computing device, such as a computer 20 as described in FIG. 13. The user device 402 may be part of the computing device 100, or may be a separate computing device that may be connected to the computing device 100 through any suitable form of wired or wireless communications. The user device 402 may include a user input device 410, which may be any suitable device for allowing the user to interact with the user device 402, including any user interface displayed on the display 420, and may be, for example, a touchscreen, keyboard, mouse, trackball, or drawing pad. The display 420 may be any suitable device for displaying graphics to a user, such as a monitor, touchscreen or non-touchscreen display, or television. The user may, for example, use the user input device 410 to select the time series 162 through a user interface of the graph generator 130.

FIG. 5 shows an example visualization suitable for visualization of dynamic events and anomaly detection according to an implementation of the disclosed subject matter. A time series graph 500 may be displayed on the display 400. The time series graph 500 may be, for example, a two-dimensional graph with a y-axis 501 that represents overall target metric for data points, and an x-axis 502 that represents time. The graph generator 130 may plot data points from the time series 162, including the data point 205, on the time series graph 500, according to the overall target metric for each data point at the timestamp for each data point. For example, the time series 162 may include data points 511, 512, 513, 514, 515, 516, 517, 518, 519, 520, 521, 522, 523, 524, 525, 526, and 205, which may have been generated by the data point generator 110 at 24 hour intervals based on event metric measurements for events of a campaign, and may be visually displayed on the time series graph 500. The data point 205 may have been flagged as anomalous by the anomaly detector 120. The graph generator 130 may visually indicate that the data point 205 was flagged as anomalous on the time series graph 500, for example, by changing the color used to display the data point 205.

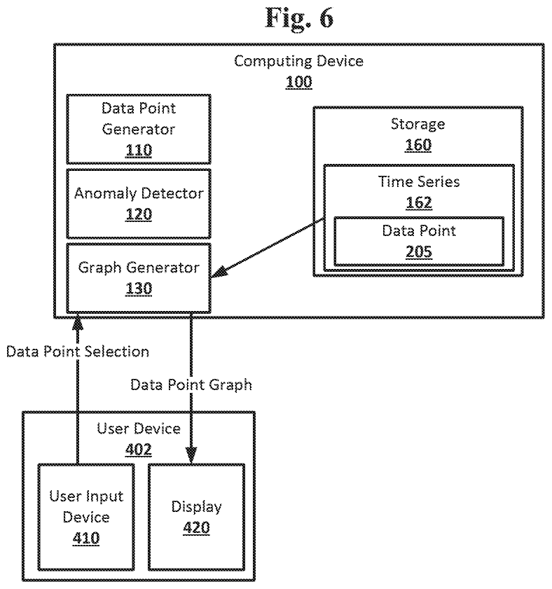

FIG. 6 shows an example arrangement for visualization of dynamic events and anomaly detection according to an implementation of the disclosed subject matter. A user of the user device 402 may select a data point from the time series graph 500 using the user input device 410. For example, the user may select the data point 205.

The data point selection made by the user may be sent from the user device 402 to the computing device 100. The graph generator 130 may retrieve the selected data point, for example, the data point 205, from the storage 160. The graph generator may generate a visualization in the form of a data point graph for the selected data point using the data from the selected data point.

The data point graph generated by the graph generator 130 may, for example, include nodes representing the events from the selected data point and a hidden node. Edges may connect each node of the data point graph to the hidden node. The sizes of nodes in the data point graph may represent the influence scores of the events represented by the nodes. The widths of edges between the nodes and the hidden node in the data point graph may represent the magnitude of the adjusted changes in the measurements of target metrics for the events represented by the nodes. The edges between the nodes and hidden node may also visually display whether the adjusted changes in the measurements of the target metrics for the events represented by the nodes are positive or negative, for example, using different colorings of the edges. The graph generator 130 may send the data point graph to the user device 402, where it may be displayed on the display device 420.

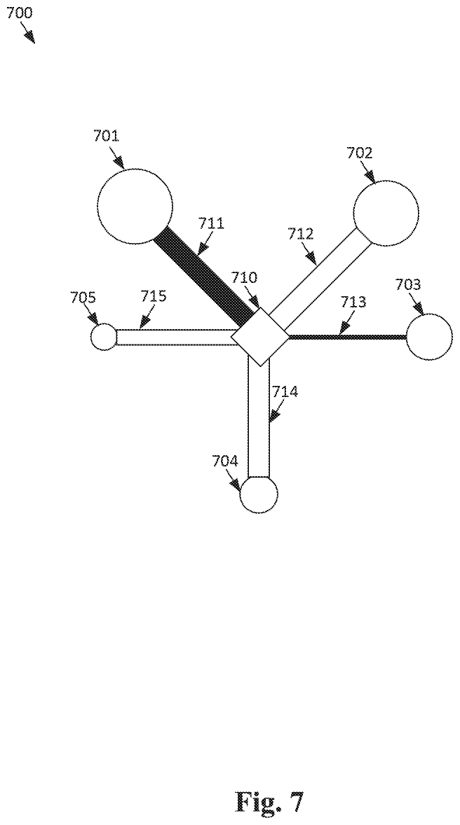

FIG. 7 shows an example visualization for visualization of dynamic events and anomaly detection according to an implementation of the disclosed subject matter. A data point graph 700 for s data point selected by a user from the time series graph 500 may be displayed to the user, for example, on the display device 420. For example, the user may select the data point 205, and the graph generator 130 may generate the data point graph 700 using data from the data point 205.

The data point graph 700 may include nodes 701, 702, 703, 704, and 705, which may each represent an event from the data point 205. Each event in the data point 205 may have a corresponding node in the data point graph 700. For example, the node 701 may represent the sending of introductory emails, the node 702 may represent the sending of follow-up emails, the node 703 may represent the sending of push notifications, the node 704 may represent the serving of a webpage for a product, and the node 705 may represent the serving of a webpage for checking out from an online store. Each of the events represented by the nodes 701, 702, 703, 704, and 705 may be part of the same campaign, for example, a marketing campaign for a product sold through an online store.

The sizes of the nodes 701, 702, 703, 704, and 705 may be based on their influence scores, which may have been determined by the data point generator 110 using measurements of traffic volume metrics for the events represented by the nodes 701, 702, 703, 704, and 705. For example, the node 702 may represent an event for which the measurement of the traffic volume metric was double the measurement of the traffic volume metric for the event represented by the node 703, resulting in the event represented by the node 702 having an influence score that is double the influence sore for event represented by the node 703. The node 702 may be displayed in the data point graph 700 as being twice the size of the node 703.

The nodes 701, 702, 703, 704, and 705 may be connected to a hidden node 710 by edges 711, 712, 713, 714, and 715. The nodes 701, 702, 703, 704, and 705 may be arranged around the hidden node 710 in any suitable manner, and in any suitable order. For example, the nodes 701, 702, 703, 704, and 705 may be ordered by influence score in a clockwise manner around the hidden node 710. The widths of the edges 711, 712, 713, 714, and 715 may be based on the adjusted changes in measurements of target metrics for the events represented by the nodes 701, 702, 703, 704, and 705. For example, the edge 711 may connect the node 701 to the hidden node 710. The edge 712 may connect the node 702 to the hidden node 710. The magnitude of the adjusted change in the measurement of the target metric for the event represented by the node 701 may be greater than the magnitude of the adjusted change in measurement of the target metric for the event represented by the node 702. The edge 711 may be displayed with a greater width than the edge 712, representing the greater magnitude of the adjusted change in measurement of the target metric for the event represented by the node 701.

The edges 711, 712, 713, 714, and 715 may also visually display the sign of the adjusted change in measurement of the target metric, for example, whether it is positive or negative, for the event represented by the node they connect to the hidden node 710. For example, the adjusted change in the measurement of the target metric for the event represented by the node 701 may be negative. This may indicate that the measurement of the target metric for the event represented by the node 701 decreased between the data point 526 and the data point 205. The edge 711 may be displayed with a coloration that may represent that the adjusted change in the measurement of the target metric for event represented by the node 701 was negative. The adjusted change in the measurement of the target metric for the event represented by the node 702 may be positive. The edge 712 may be displayed with a coloration different from the coloration of the edge 711, representing that the adjusted change in the measurement of the target metric for the event represented by the node 702 was positive.

A user may visually inspect the data point graph 700 to determine, for example, why the data point 205 was flagged as anomalous by the anomaly detector 120. For example, the user may determine, based on the width of the edges 715 and 714, that the events represented by the node 704 and node 705 had improved performance over the time period represented by the data point 205 when compared to the immediately preceding time period represented by the data point 526. This may account for the data point 205 having a measurement for the overall target metric higher than the measurement for the overall target metric for the data point 526.

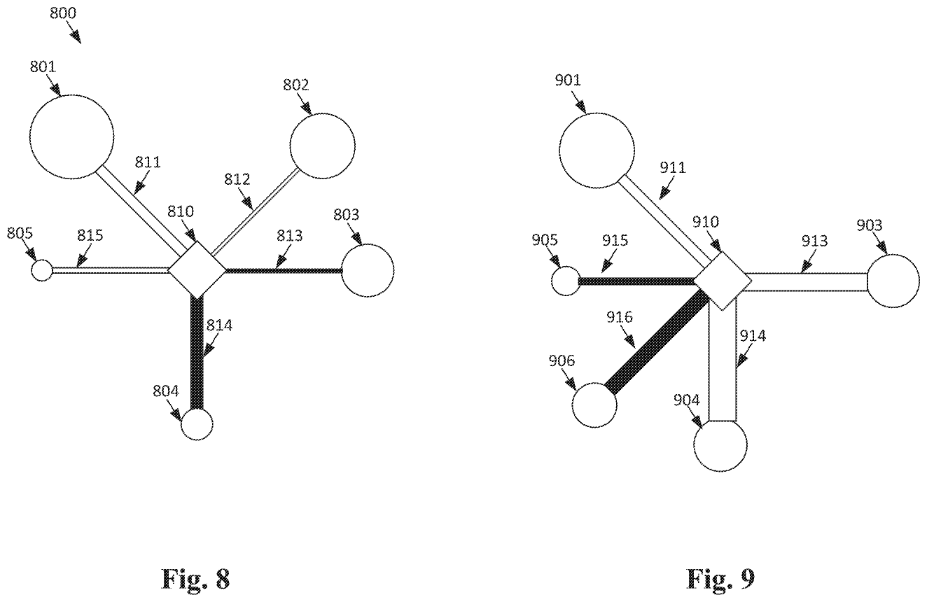

FIG. 8 shows an example visualization for visualization of dynamic events and anomaly detection according to an implementation of the disclosed subject matter. A user may select any number of data points from the time series graph 500 to for which to view data point graphs. This may allow a user to visually compare different data point graphs. For example, the user may select the data point 526, which may cause the graph generator 130 to generate a data point graph 800 that may be displayed on the display 420. The data point graph 800 may include nodes 801, 802, 803, 804, and 805, which may represent the same events as the nodes 701, 702, 703, 704, and 705 over a different time period. The edges 811, 812, 813, 814, and 815 may connect the nodes 801, 802, 803, 804, and 805 to a hidden node 810. The measurement of the overall target metric for the data point 526, represented by the data point graph 800, may be lower than the measurement of the overall target metric for the data point 205. A user may be able to visually compare the data point graph 800 and the data point graph 700 to determine which events may be responsible for the differences in the measurements of the overall target metric. Because the sizes of the nodes may be normalized by basing them on an event's percentage of the total traffic volume for a data point, the sizes of nodes may be compared across data point graphs to determine which events have relatively increased or decreased effects on the overall target metric between data points. For example, the node 801 may be larger than the node 701. This may indicate that the event represented by the node 701 and the node 801 had a greater percentage of the total traffic volume, and a higher influences score, over the time period represented by the data point 526 than over the time period represented by the data point 205. The edge 712 may be wider than the edge 812, which may indicate that the adjusted change in the target metric for the event represented by the node 702 and node 802 was greater during the time period represented by the data point 205 than over the time period represented by the data point 206.

FIG. 9 shows an example visualization for visualization of dynamic events and anomaly detection according to an implementation of the disclosed subject matter. The user may, for example, select the data point 525, which may cause the graph generator 130 to generate a data point graph 900 that may be displayed on the display 420. The data point graph 900 may include nodes 901, 903, 904, 905, which may represent the same events as the nodes 701, 703, 704, and 705. The data point graph 900 may also include the node 906, which may represent an event that may have been removed from the campaign after the time period represented by the data point 525 and may not have a representative node on the data point graph 700 or the data point graph 800. The data point graph 900 may not include a node that represents the event represented by the node 702 and the node 802, as the event may have been added to the campaign after the time period represented by the data point 525. The nodes 901, 903, 904, 905, and 906 may be connected to a hidden node 910 by edges 911, 913, 914, 915, and 916.

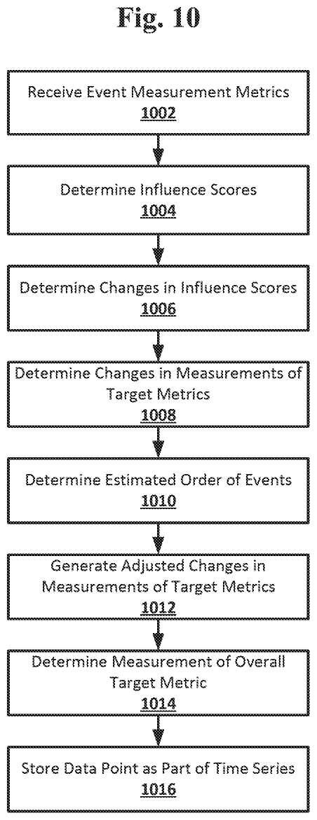

FIG. 10 shows an example procedure suitable for visualization of dynamic events and anomaly detection according to an implementation of the disclosed subject matter. At 1002, event metric measurements may be received. For example, the data point generator 110 on the computing device 100 may receive event metric measurements taken for events monitored by the computing device 100 or any other suitable computing device or system. The event metric measurements may include, for example, measurements of traffic volume for the events, and measurements of target metrics for the events. The event metric measurements may be taken over any suitable period of time. All of the events for which event metric measurements are received may be part of the same campaign.

At 1004, influence scores may be determined. For example, the data point generator 110 may determine a total traffic volume by summing all of the measurements for the traffic volume metric received in the event measurement metrics. The influence score for an event may be determined by dividing the measurement for the traffic volume metric for that event by the total traffic volume. The data point generator 110 may determine influence scores for each of the events for which event measurement metrics were received.

At 1006, changes in influence scores may be determined. For example, the data point generator 110 may determine a change in influence score for each of the events for which event measurement metrics were received. The change in influence score for an event may be determined by subtracting the influence score determined for the event for an immediately prior data point from the current influence score for the event. For example, the change in influence score being determined for the data point 205 for an event may be determined by subtracting the influence score determined for the event in the data point 526 from the influence score for the event determined that will be part of the data point 205. If there the event does not have an influence score in the immediately prior data point, the change in influence score may be set to be equal to the current influence score for the event.

At 1008, changes in measurements of target metrics may be determined. For example, the data point generator 110 may determine a change in measurement of a target metric for each of the events for which event measurements were received. The change in measurement of a target metric for an event may be determined by subtracting the measurement of the target metric for the event for an immediately prior data point from the most current measurement of the target metric for the event. For example, the change in measurement of a target metric being determined for the data point 205 for an event may be determined by subtracting the measurement of the target metric in the data point 526 for the event from the measurement of the target metric for the event that will be part of the data point 205. If there the event does not have an influence score in the immediately prior data point, the change in influence score may be set to be equal to the current influence score for the event.

At 1010, an estimated order of events may be determined. For example, the data point generator 110 may determine an estimated order for the events for which event metric measurements were received based on the influence scores determined for the events. The estimated order of events may order the events from highest influence score to lowest score.

At 1012, adjusted changes in measurements of target metrics may be generated. For example, the data point generator 110 may determine an adjusted change in the measurement of a target metric for each of the events for which event measurements were received by adjusting the determined changes in the measurements in the measurements of the target metrics for the events. The adjusted change in measurement of a target metric for an event may be generated through adjusting the change in measurement of the target metric for the event based on both the change in influence score determined for the event and on the position of the event in the estimated order of the events. For example, the change in measurement of the target metric for an event may have its magnitude increased when the event has a positive change in influence score and decreased when the event has a negative change in influence score. An exponential decay effect may be used to adjust the change in the measurement of the target metric for an event based on the position of the event in the estimated order of events. For example, events at the beginning of the estimate order, having higher influence scores, may have the magnitude of the change in measurement of the target metric reduced, while events towards the end of the estimated order may have the magnitude of the change in the measurement of the target metric increased.

At 1014, an overall target metric may be determined. For example, the data point generator 110 may determine an overall target metric for the data point that will include the data determined from the event measurement metrics, such as the data point 205. The overall target metric may be determined by, for example, multiplying the influence score for each event by the measurement of the target metric for the event, and summing the results across all events from the data point being generated to generate the overall target metric measurement for the data point being generated.

At 1016, a data point may be stored. For example, the data point generator 110 may generate a data point, such as the data point 205, and store the generated data point as part of a time series, for example, time series 162 in the storage 160. The data point may be generated to include any suitable data, such as a timestamp for the data point based on the time the event metric measurements were received, or the time period covered by the event metric measurements, identification of the events for which event metric measurements were received, the overall target metric measurement, and data for the events, including the measurements of the traffic volume metric and target metric, influence score, change in influence score, change in measurement of the target metric, and adjusted change in measurement of the target metric for each of the events. The data point, such as the data point 205, may be stored as part of a time series in any suitable format. A time series, such as the time series 162, may include any number of data points, which may have been generated at any suitable intervals and may represented any suitable time periods.

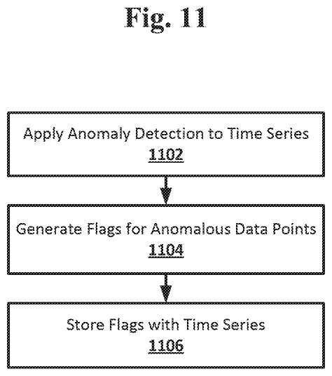

FIG. 11 shows an example procedure suitable for visualization of dynamic events and anomaly detection according to an implementation of the disclosed subject matter. At 1102, anomaly detection may be applied to a time series. For example, the anomaly detector 120 may apply any suitable form of one-dimensional anomaly detection to the time series 162. The anomaly detector 120 may apply anomaly detection to the data points of the time series 162 based on the overall target metric measurements for the data points.

At 1104, flags may be generated for anomalous data point. For example, the anomaly detector 120 may generate a flag for any data point from the time series 162 determined to be anomalous based on the application of anomaly detection to the time series 162. The anomaly detector 120 may, for example, determine that the data point 205 is anomalous. The anomaly detector 120 may generate a flag for the data point 205.

At 1106, flags may be stored with the time series. For example, the anomaly detector 120 may store any flags generated for anomalous data points of the time series 162 with the time series 162 in the storage 160. A flag for a data point determined to anomalous may be stored in any suitable manner, including, for example, with the data point. For example, the flag for the data point 205 may be stored as part of the data point 205. Flags may also be stored separately from the data points. For example, the flags may be stored in a list as metadata for the time series 162.

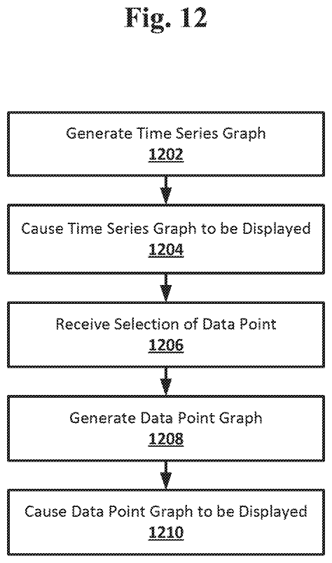

FIG. 12 shows an example procedure suitable for visualization of dynamic events and anomaly detection according to an implementation of the disclosed subject matter. At 1202, a time series graph may be generated. For example, the graph generator 130 may generate the time series graph 500 for the time series 162. The time series graph 500 may be a two-dimensional graph on which data points from the time series 162 may be plotted according to their timestamps, for example, based on the time when the data point was generate or the time period represented by the data point, and according to their measurements for the overall target metric. Data points from the time series 162 flagged as anomalous by the anomaly detector 120, such as the data point 205, may be visually distinguished on the time series graph 500 from other, non-flagged data points.

At 1204, the time series graph may be caused to be displayed. For example, the graph generator 130 may send the time series graph 500 to the user device 402, which may display the time series graph 500 on the display 420. The time series graph 500 may be displayed in any suitable manner, and data points flagged as anomalous may be visually distinguished from non-anomalous data points in any suitable manner. For example, data points flagged as anomalous, such as the data point 205, may be displayed using a different color or shape than data points that were not flagged.

At 1206, a selection of a data point may be received. For example, a user may select one of the data points, such as the data point 205 from the time series graph 500 using the user input device 410. The user's selection of a data point may be sent to the graph generator 130 of the computing device 100.

At 1208, a data point graph may be generated. For example, the graph generator 130 may generate a data point graph, such as the data point graph 700, using data for the selected data point, for example, the data point 205. The graph may be generated by, for example, representing each event from the selected data point with a node, such as the nodes 701, 702, 703, 704, and 705, and connecting the nodes to a hidden node, such as the hidden node 710, with edges, such as the edges 711, 712, 713, 714, and 715. The size of a node in the data point graph may be based on, for example, proportional to, the influence score for the event represented by the node. The width of an edge between a node and the hidden node may be based on the adjusted change in measurement for the target metric for the event represented by the node. The edge may also be colored based on whether the adjusted change in measurement for the target metric for the event represented by the node is positive or negative.

At 1210, the data point graph may be caused to be displayed. For example, the graph generator 130 may send the data point graph 700 to the user device 402, which may display the data point graph 700 on the display 420. The data point graph 500 may be displayed in any suitable manner. The nodes 701, 702, 703, 704, and 705 of the data point graph 700 may, for example, be displayed arranged in a circle around the hidden 710, with the sizes of the nodes 701, 702, 703, 704, and 705 being proportional to the influence scores of the events from the data point 205 represented by the nodes 701, 702, 703, 704, and 705. The edges 711, 712, 713, 714, and 715 may be displayed with widths based on the magnitudes of the adjusted changes in measurements of the target metrics for the events from the data point 205 represented by the nodes 701, 702, 703, 704, and 705 that the edges 711, 712, 713, 714, and 715 connect to the hidden node 710. The coloration of the edges 711, 712, 713, 714, and 715 may indicate whether the adjusted changes in measurements of the target metrics for the events from the data point 205 represented by the nodes 701, 702, 703, 704, and 705 that the edges 711, 712, 713, 714, and 715 connect to the hidden node 710 are positive or negative.

Implementations of the presently disclosed subject matter may be implemented in and used with a variety of component and network architectures. FIG. 13 is an example computer 20 suitable for implementing implementations of the presently disclosed subject matter. As discussed in further detail herein, the computer 20 may be a single computer in a network of multiple computers. As shown in FIG. 13, computer may communicate a central component 30 (e.g., server, cloud server, database, etc.). The central component 30 may communicate with one or more other computers such as the second computer 31. According to this implementation, the information obtained to and/or from a central component 30 may be isolated for each computer such that computer 20 may not share information with computer 31. Alternatively or in addition, computer 20 may communicate directly with the second computer 31.

The computer (e.g., user computer, enterprise computer, etc.) 20 includes a bus 21 which interconnects major components of the computer 20, such as a central processor 24, a memory 27 (typically RAM, but which may also include ROM, flash RAM, or the like), an input/output controller 28, a user display 22, such as a display or touch screen via a display adapter, a user input interface 26, which may include one or more controllers and associated user input or devices such as a keyboard, mouse, WiFi/cellular radios, touchscreen, microphone/speakers and the like, and may be closely coupled to the I/O controller 28, fixed storage 23, such as a hard drive, flash storage, Fibre Channel network, SAN device, SCSI device, and the like, and a removable media component 25 operative to control and receive an optical disk, flash drive, and the like.

The bus 21 enable data communication between the central processor 24 and the memory 27, which may include read-only memory (ROM) or flash memory (neither shown), and random access memory (RAM) (not shown), as previously noted. The RAM can include the main memory into which the operating system and application programs are loaded. The ROM or flash memory can contain, among other code, the Basic Input-Output system (BIOS) which controls basic hardware operation such as the interaction with peripheral components. Applications resident with the computer 20 can be stored on and accessed via a computer readable medium, such as a hard disk drive (e.g., fixed storage 23), an optical drive, floppy disk, or other storage medium 25.

The fixed storage 23 may be integral with the computer 20 or may be separate and accessed through other interfaces. A network interface 29 may provide a direct connection to a remote server via a telephone link, to the Internet via an internet service provider (ISP), or a direct connection to a remote server via a direct network link to the Internet via a POP (point of presence) or other technique. The network interface 29 may provide such connection using wireless techniques, including digital cellular telephone connection, Cellular Digital Packet Data (CDPD) connection, digital satellite data connection or the like. For example, the network interface 29 may enable the computer to communicate with other computers via one or more local, wide-area, or other networks, as shown in FIG. 14.

Many other devices or components (not shown) may be connected in a similar manner (e.g., document scanners, digital cameras and so on). Conversely, all of the components shown in FIG. 13 need not be present to practice the present disclosure. The components can be interconnected in different ways from that shown. The operation of a computer such as that shown in FIG. 13 is readily known in the art and is not discussed in detail in this application. Code to implement the present disclosure can be stored in computer-readable storage media such as one or more of the memory 27, fixed storage 23, removable media 25, or on a remote storage location.

FIG. 14 shows an example network arrangement according to an implementation of the disclosed subject matter. One or more clients 10, 11, such as computers, microcomputers, local computers, smart phones, tablet computing devices, enterprise devices, and the like may connect to other devices via one or more networks 7 (e.g., a power distribution network). The network may be a local network, wide-area network, the Internet, or any other suitable communication network or networks, and may be implemented on any suitable platform including wired and/or wireless networks. The clients may communicate with one or more servers 13 and/or databases 15. The devices may be directly accessible by the clients 10, 11, or one or more other devices may provide intermediary access such as where a server 13 provides access to resources stored in a database 15. The clients 10, 11 also may access remote platforms 17 or services provided by remote platforms 17 such as cloud computing arrangements and services. The remote platform 17 may include one or more servers 13 and/or databases 15. Information from or about a first client may be isolated to that client such that, for example, information about client 10 may not be shared with client 11. Alternatively, information from or about a first client may be anonymized prior to being shared with another client. For example, any client identification information about client 10 may be removed from information provided to client 11 that pertains to client 10.

More generally, various implementations of the presently disclosed subject matter may include or be implemented in the form of computer-implemented processes and apparatuses for practicing those processes. Implementations also may be implemented in the form of a computer program product having computer program code containing instructions implemented in non-transitory and/or tangible media, such as floppy diskettes, CD-ROMs, hard drives, USB (universal serial bus) drives, or any other machine readable storage medium, wherein, when the computer program code is loaded into and executed by a computer, the computer becomes an apparatus for practicing implementations of the disclosed subject matter. Implementations also may be implemented in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing implementations of the disclosed subject matter. When implemented on a general-purpose microprocessor, the computer program code segments configure the microprocessor to generate specific logic circuits. In some configurations, a set of computer-readable instructions stored on a computer-readable storage medium may be implemented by a general-purpose processor, which may transform the general-purpose processor or a device containing the general-purpose processor into a special-purpose device configured to implement or carry out the instructions. Implementations may be implemented using hardware that may include a processor, such as a general purpose microprocessor and/or an Application Specific Integrated Circuit (ASIC) that implements all or part of the techniques according to implementations of the disclosed subject matter in hardware and/or firmware. The processor may be coupled to memory, such as RAM, ROM, flash memory, a hard disk or any other device capable of storing electronic information. The memory may store instructions adapted to be executed by the processor to perform the techniques according to implementations of the disclosed subject matter.

The foregoing description, for purpose of explanation, has been described with reference to specific implementations. However, the illustrative discussions above are not intended to be exhaustive or to limit implementations of the disclosed subject matter to the precise forms disclosed. Many modifications and variations are possible in view of the above teachings. The implementations were chosen and described in order to explain the principles of implementations of the disclosed subject matter and their practical applications, to thereby enable others skilled in the art to utilize those implementations as well as various implementations with various modifications as may be suited to the particular use contemplated.

1. A computer-implemented method comprising:
receiving, through a user interface of a computing device, a selection of a data point of a time series, wherein the data point represents a measurement of an overall target metric for events at a point in time;
causing, on a display device, display of a graph for the data point, wherein displaying the graph for the data point comprises:
displaying nodes for the events, wherein the displayed size of one of the nodes that corresponds to one of the events is based on an influence score for the one of the events; and
displaying an edge between each of the nodes and a hidden node, wherein a width of an edge between the one of the nodes and the hidden node represents an adjusted change in a measurement of a target metric for the one of the events corresponding to the one of the nodes, and a color of the edge between the one of the nodes and the hidden node represents whether the adjusted change in the measurement of the target metric for the one of the one of the events corresponding to the one of the nodes is positive or negative.

2. The computer-implemented method of claim 1, wherein the time series comprises multiple data points, each data point generated at a different point in time, and further comprising applying anomaly detection to the data points of the time series.

3. The computer-implemented method of claim 2, further comprising storing a flag for data points flagged as anomalous as a result of applying the anomaly detection to the data points of the time series.

4. The computer-implemented method of claim 3, further comprising, before receiving, through a user interface of a computing device, a selection of a data point of a time series, causing a time series graph for the time series to be displayed on the display of the user device, wherein the data points flagged as anomalous are visually marked on the time series graph.

5. The computer-implemented method of claim 1, wherein the events are associated with electronic communications, and wherein the targeted metric comprises engagement with the electronic communications.

6. The computer-implemented method of claim 1, wherein the influence score for the one of the events is determined based on a ratio of a measurement of a traffic volume for the one of the events to the total of measurements of traffic volumes for all of the events.

7. The computer-implemented method of claim 1, wherein the adjusted change in the measurement of the target metric for the one of the events is determined by determining for the one of the events a change in the measurement of the target metric for the one of the events from a previously received measurement of the target metric for the events,
generating an adjusted change in the measurement of the target metric for the one of the events by using the influence score for the one of the events event to adjust the change in the measurement of the target metric determined for the one of the events,
determining an estimated order for the events based on the influence scores for the events, and
adjusting the adjusted change in the measurement of the target metric for the one of the events based on where the one of the events is in the order for the events.

8. The computer-implemented method of claim 7, wherein adjusting the adjusted change in the measurement of the target metric for the one of the events based on where the one of the events is in the order for the events uses an exponential decay effect.

9. The computer-implemented method of claim 1, wherein the measurement for the overall target metric for the data point and the point in time is determined by combining the measurements of target metrics for the events.

10. A computer-implemented system for visualization of dynamic events and anomaly detection comprising:
one or more storage devices;
a display device;
a processor that receives, through a user interface of a computing device, a selection of a data point of a time series, wherein the data point represents a measurement of an overall target metric for events at a point in time,
causes, on a display device, display of a graph for the data point, wherein the display of the graph for the data point comprises a display of nodes for the events, wherein the displayed size of one of the nodes that corresponds to one of the events is based on an influence score for the one of the events and a display of an edge between each of the nodes and a hidden node, wherein a width of an edge between the one of the nodes and the hidden node represents an adjusted change in a measurement of a target metric for the one of the events corresponding to the one of the nodes, and a color of the edge between the one of the nodes and the hidden node represents whether the adjusted change in the measurement of the target metric for the one of the events corresponding to the one of the nodes is positive or negative.

11. The computer-implemented system of claim 10, wherein the time series comprises multiple data points, each data point generated at a different point in time, and further comprising applying anomaly detection to the data points of the time series.

12. The computer-implemented system of claim 11, wherein the processor further stores in the one or more storage devices a flag for data points flagged as anomalous as a result of applying the anomaly detection to the data points of the time series.

13. The computer-implemented system of claim 12, wherein the processor causes a time series graph for the time series to be displayed on the display device, wherein the data points flagged as anomalous are visually marked on the time series graph, before receiving, through a user interface of a computing device, a selection of a data point of a time series.

14. The computer-implemented system of claim 10, wherein the events are associated with electronic communications, and wherein the targeted metric comprises engagement with the electronic communications.

15. The computer-implemented system of claim 10, wherein the influence score for the one of the events is determined based on a ratio of a measurement of a traffic volume for the one of the events to the total of measurements of traffic volumes for all of the events.

16. The computer-implemented system of claim 10, wherein the processor determines that adjusted change in the measurement of the target metric for the one of the events by determining for the one of the events a change in the measurement of the target metric for the one of the events from a previously received measurement of the target metric for the events,
generating an adjusted change in the measurement of the target metric for the one of the events by using the influence score for the one of the events event to adjust the change in the measurement of the target metric determined for the one of the events,
determining an estimated order for the events based on the influence scores for the events, and
adjusting the adjusted change in the measurement of the target metric for the one of the events based on where the one of the events is in the order for the events.

17. The computer-implemented system of claim 16, wherein the processor adjusts the adjusted change in the measurement of the target metric for the one of the events based on where the one of the events is in the order for the events uses an exponential decay effect.

18. The computer-implemented system of claim 10, wherein the measurement for the overall target metric for the data point and the point in time is determined by combining the measurements of target metrics for the events.

19. A system comprising: one or more computers and one or more storage devices storing instructions which are operable, when executed by the one or more computers, to cause the one or more computers to perform operations comprising:
receiving, through a user interface of a computing device, a selection of a data point of a time series, wherein the data point represents a measurement of an overall target metric for events at a point in time;
causing, on a display device, display of a graph for the data point, wherein displaying the graph for the data point comprises:
displaying nodes for the events, wherein the displayed size of one of the nodes that corresponds to one of the events is based on an influence score for the one of the events; and
displaying an edge between each of the nodes and a hidden node, wherein a width of an edge between the one of the nodes and the hidden node represents an adjusted change in a measurement of a target metric for the one of the events corresponding to the one of the nodes, and a color of the edge between the one of the nodes and the hidden node represents whether the adjusted change in the measurement of the target metric for the one of the events corresponding to the one of the nodes is positive or negative.

20. The system of claim 19, wherein the time series comprises multiple data points, each data point generated at a different point in time, and further comprising applying anomaly detection to the data points of the time series.
